(19) United States
(12) Patent Application Publication
(10) Pub. No.: US 2008/0247926 A1
(43) Pub. Date: Oct. 9, 2008

(54) CATALYTIC PEROXIDE OXYGEN GENERATOR-CONCENTRATOR

(76) Inventor: James Osterloh, W. Richland, WA (US)

Correspondence Address: SHELDON MAK ROSE & ANDERSON PC, 100 Corson Street, Third Floor, PASADENA, CA, 91103-3842, US

(21) Appl. No.: 11/697,265

(22) Filed: Apr. 5, 2007

(51) Int. Cl. C01B 13/02

(52) U.S. Cl. 423/219

(57) ABSTRACT

A method for generating concentrated oxygen at elevated pressure comprising the steps of (a) injecting a molecular oxygen precursor into a pressurized reaction vessel; (b) contacting the molecular oxygen precursor within a reaction vessel with a catalyst to cause the molecular oxygen precursor to decompose to liquid water and gaseous reaction products, the gaseous reaction products including a gaseous condensible moiety and a gaseous non-condensible moiety, the gaseous non-condensible moiety containing molecular oxygen the concentration of which is C₁; and (c) condensing and removing a portion of the gaseous condensible moiety to provide a molecular oxygen-rich gaseous stream having an oxygen concentration of C₂, wherein C₂ is greater than C₁.

### FIELD OF THE INVENTION

This invention relates generally to processes and equipment for the controlled generation of concentrated oxygen and, more specifically, to processes and equipment for generating concentrated oxygen using a catalyst that dissociates hydrogen peroxide into water and oxygen.

### BACKGROUND OF THE INVENTION

Due to the inherent reactive nature of oxygen, storage of oxygen in most forms is done with some level of risk. Pure oxygen can be stored in pressurized metal bottles, though for many applications the risk of doing so would be considered too high.

Oxygen can also be stored cryogenically as a liquid; however the temperature must be maintained below −297.3° F., requiring special equipment. Oxygen can be obtained directly from air, but the concentration of oxygen in air is limited to about 21% by volume. There are processes in industry that require concentrations of oxygen greater than 21%.

Oxygen Generator processes are well-known in the art. For example, U.S. Pat. Nos. 7,116,696, 7,150,280, 4,488,951, 3,882,223, the entireties of which are incorporated herein by this reference, describe various forms of oxygen generator processes.

In typical examples of prior art oxygen generators, oxygen is delivered at a pressure of one atmosphere or less. While for some applications, delivery of oxygen is perfectly suitable at one atmosphere or less, in industry, there are applications that require oxygen to be delivered at a much higher pressure, sometimes hundreds and even thousands of pounds per square inch.

Another typical characteristic of existing oxygen generators is that they supply oxygen at a relatively low concentration; for example 15% by volume concentration. Again, for some applications this is perfectly suitable. Many industrial applications, however, would benefit greatly from an oxygen delivery system that can deliver about 90% by volume oxygen.

Accordingly, there is a need for an oxygen generator process that can deliver oxygen at a higher pressure and a higher concentration than can typical generators of the prior art.

### SUMMARY

The invention satisfies this need. The invention is a method for forming a molecular oxygen-rich gaseous stream comprising the steps of (a) injecting a molecular oxygen precursor into a pressurized reaction vessel; (b) contacting the molecular oxygen precursor within a reaction vessel with a catalyst to cause the molecular oxygen precursor to decompose to liquid water and gaseous reaction products, the gaseous reaction products including a gaseous condensible moiety and a gaseous non-condensible moiety, the gaseous non-condensible moiety containing molecular oxygen the concentration of which is C₁; and (c) condensing and removing a portion of the gaseous condensible moiety to provide a molecular oxygen-rich gaseous stream having an oxygen concentration of C₂, wherein C₂ is greater than C₁.

### DRAWINGS

These and other features, aspects and advantages of the present invention will become better understood with reference to the following description, appended claims and accompanying drawings where:

FIG. 1 is a process flow diagram illustrating an oxygen generator-concentrator process having features of the invention.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a method of generating concentrated oxygen at pressure comprising the steps of (a) injecting a molecular oxygen precursor into a pressurized reaction vessel; (b) contacting the molecular oxygen precursor within the pressurized reaction vessel with a catalyst to cause the molecular oxygen precursor to decompose to gaseous reaction products, including a gaseous condensible moiety and a gaseous non-condensible moiety, the gaseous non-condensible moiety containing molecular oxygen the concentration of which is C₁; and (c) condensing and removing a portion of the gaseous condensible moiety to provide a molecular oxygen-rich gaseous stream having an oxygen concentration of C₂, wherein C₂ is greater than C₁.

As the hydrogen peroxide is exposed to the catalyst, the hydrogen peroxide dissociates into water and gaseous oxygen according to the following formula:

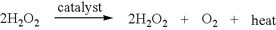

It is important to note that the catalyst is not consumed in the reaction. For every two moles of pure hydrogen peroxide that are injected, exactly two moles of water and one mole of molecular oxygen (O₂) is formed. Thus, if the precise amount of hydrogen peroxide is known, one can predict with a high degree of precision, how much water and how much oxygen will be produced. Because pure hydrogen peroxide is very expensive, very reactive and difficult to use, for the purposes of the invention, 50% by weight hydrogen peroxide is a better choice.

Using 50% by weight hydrogen peroxide (aqueous), the formula becomes:

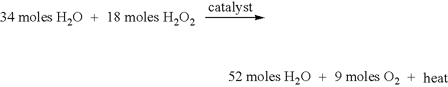

In a fully gaseous system, the molar ratio equals the ratio of the partial pressures of each of the gasses present and is also an expression of the volume percent concentration. If nothing is removed from the system, the equation shown above indicates that for every 61 moles of product, 9 moles are O₂. This means that the percent oxygen present is 9/61 or 14.7% volume:

52H₂O+9O₂ [symbol] 14.7% O₂

If the system is maintained subcooled, the water will condense and the oxygen will not. Condensing the water effectively removes it from the gaseous system. Pumping the condensate out of the reaction vessel ensures removal from the system. If half of the water is removed from the system, this raises the oxygen concentration in the gas space as follows:

26H₂O+9O₂ [symbol] 25.7% O₂

It is obvious that if all of the water is removed from the system the remaining gas would be 100% oxygen. In practical applications under pressure, it would be very difficult to separate 100% of the oxygen from the water due to the vapor pressure of the water and the tendency for oxygen to dissolve in water. Although 100% oxygen enrichment would be very difficult, if not impossible to reach, 90% volume gaseous oxygen is achievable by removing most of the water from the system:

1H₂O+9O₂ [symbol] 90% O₂

Hydrogen peroxide is pumped into the system at a pressure sufficient to overcome steady state pressure of the reaction vessel. Water is removed from the system by throttling a flow control valve. The bottom exit of the reaction vessel flows into a vertical heat exchanger. This heat exchanger ensures the liquid effluent is subcooled. Any oxygen bubbles that get entrained in the liquid effluent stream either rise through the liquid back through the catalyst to the oxygen gas space or are collapsed and carried in the water as dissolved oxygen. Enriched oxygen exits through the top exit of the reaction vessel through a backpressure control valve that opens when the reaction vessel reaches a preset pressure.

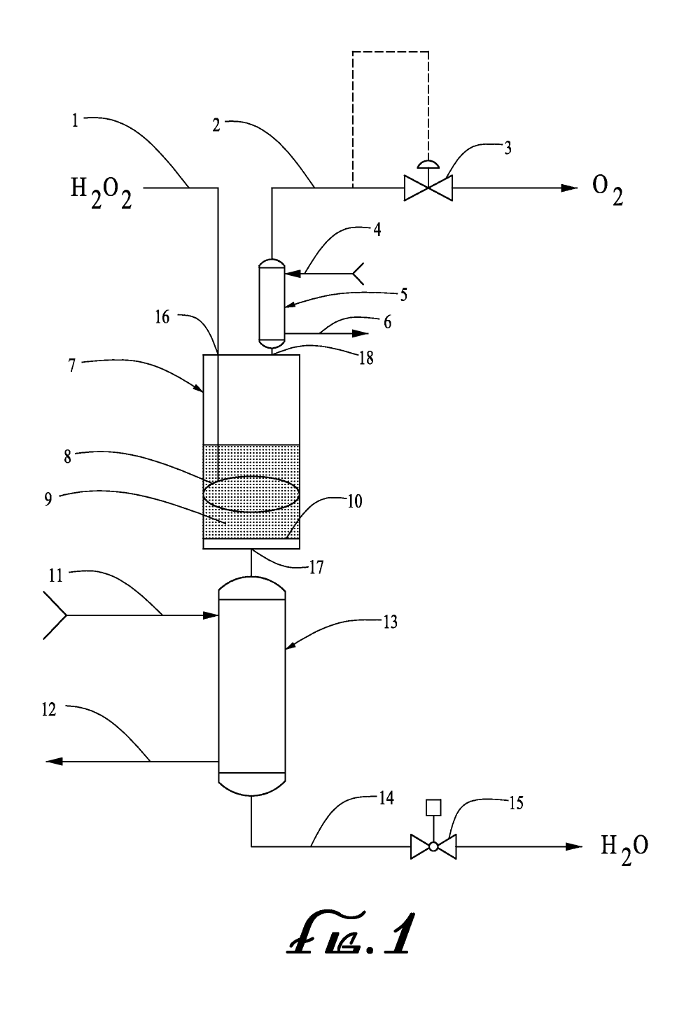

One embodiment of the invention is illustrated in the flow diagram set forth in FIG. 1. In this embodiment, hydrogen peroxide is decomposed to water and oxygen in a reactor reaction vessel 7. The reaction vessel 7 has a hydrogen peroxide inlet port 16, a liquid outlet port 17 and a gas outlet port 18. The reaction vessel 7 is typically a pressure vessel having a wall thickness sufficient to safely withstand the intended operating pressure within the reaction vessel 7. Such operating pressure can conveniently be any desired pressure from near atmospheric pressures to pressures as high as several thousand pounds per square inch.

Hydrogen peroxide is delivered to the reaction vessel 7 in hydrogen peroxide injection piping 1 via the hydrogen peroxide inlet port 16. Hydrogen peroxide exits the injection piping 1 and flows into a catalyst bed 9. Typically, the catalyst bed 9 is made up of low density, high surface area silver catalyst. Also typically, the catalyst bed 9 occupies about half of the volume of the reaction vessel 7, leaving the upper half of the reaction vessel 7, as gas space.

In one embodiment of the invention, the catalyst bed 9 is comprised of granular, low density nano-porous silver catalyst. In other embodiments of the invention the catalyst bed 9 can be comprised of various other elements and metal bearing compounds.

In the embodiment illustrated in FIG. 1, a catalyst retention screen 10 is disposed within the reaction vessel 7 and is used to support the catalyst bed 9. In one embodiment, the catalyst retention screen 10 comprises a silver screen with mesh sized to preclude the escape of the catalyst granules. In other embodiments, the catalyst retention screen 10 comprises stainless steel, copper, platinum or other woven metal wire of appropriate mesh size.

A hydrogen peroxide injection sparger 8 within the reaction vessel 7 can be used to disperse the hydrogen peroxide as it exits the injection piping 1. The injection sparger 8 is typically made from a reaction resistant material such as 316/316L stainless steel. The function of the hydrogen peroxide injection sparger 8 is to distribute the hydrogen peroxide over a wide planar area rather than at a single point. This ensures efficient use of the catalyst and avoids localized depletion of the catalyst bed 9.

As hydrogen peroxide is decomposed within the reaction vessel 7, it yields liquid water, steam and oxygen. Water is removed from the reaction vessel 7 via liquid discharge piping 14 attached to the liquid outlet port 17. The amount of water exiting the reaction vessel 7 is controlled by the throttle position of a liquid discharge throttle valve 15 disposed within the liquid discharge piping 14.

The liquid water exiting the reaction vessel 7 is cooled in a liquid discharge heat exchanger 13 disposed in line within the liquid discharge piping 14. Cooling water is supplied to the liquid discharge heat exchanger 13 through a cooling water inlet 11 and is discharged from the liquid discharge heat exchanger 13 through a cooling water outlet 12. Any oxygen bubbles that are swept into the liquid discharge heat exchanger 13 either rise back up into the reaction vessel 7 or are collapsed and carried in a dissolved state with the water exiting the system.

Gaseous oxygen and steam are removed from the reaction vessel 7 via a gaseous discharge line 2 attached to the gaseous outlet port 18. Pressure within the reaction vessel 17 is maintained by a pressure control valve 3 disposed within the gaseous discharge piping 2.

As illustrated in FIG. 1, an optional gaseous discharge heat exchanger 5 can be disposed in line with the gaseous discharge piping 2. The gaseous discharge heat exchanger 5 is used in applications where a more elevated ratio of oxygen to water vapor in the gaseous discharge is desired. When water vapor enters the gaseous discharge heat exchanger 5 it is condensed and falls back into the reaction vessel 7. Cooling water is supplied to the gaseous discharge heat exchanger 5 through cooling water inlet 4 and is discharged from the gaseous discharge heat exchanger 5 through the cooling water outlet 6.

Within limits, the more water that is removed from the system, the higher the oxygen concentration of the gaseous effluent will be. The limitations are determined by two factors; 1) a partial pressure of oxygen gas will be exerted on the liquid surface and cause a certain amount of oxygen to be absorbed by the water; and 2) the partial pressure of the water vapor will cause a certain amount of water to remain in a gaseous state and exit with the oxygen through the gaseous discharge line 2. For example, if the desired concentration of oxygen is 90%, and if 34 moles of hydrogen peroxide are added to the system for every 18 moles of water (which would be the case if injecting 50% b weight hydrogen peroxide), 90% by volume oxygen would be discharged if about 51 moles of liquid water are discharged. This assumes about one mole of oxygen is discharged as gaseous water vapor with the oxygen.

The invention provides a simple, efficient and relatively inexpensive method of generated oxygen mixtures, especially high pressure concentrated mixtures. The invention differs from most prior art in the chemical oxygen generator field in two important aspects: 1) the invention supplies oxygen at pressures as high as several thousands of pounds per square inch as opposed to the typical atmospheric discharge pressure of most prior art oxygen generators; and 2) the invention has the capability of supplying pressurized oxygen at concentrations as high as about 90% by volume as opposed to prior art oxygen generators that supply oxygen at around 15% by volume.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A method for forming a molecular oxygen-rich gaseous stream comprising the steps of:
(a) injecting a molecular oxygen precursor into a pressurized reaction vessel;
(b) contacting the molecular oxygen precursor within a reaction vessel with a catalyst to cause the molecular oxygen precursor to decompose to liquid water and gaseous reaction products, the gaseous reaction products including a gaseous condensible moiety and a gaseous non-condensible moiety, the gaseous non-condensible moiety containing molecular oxygen the concentration of which is C₁; and
(c) condensing and removing a portion of the gaseous condensible moiety to provide a molecular oxygen-rich gaseous stream having an oxygen concentration of C₂, wherein C₂ is greater than C₁.

2. The method of claim 1 wherein the molecular oxygen precursor is hydrogen peroxide.

3. The method of claim 1 wherein the catalyst is comprised of silver.

4. The method of claim 1 wherein the catalyst is comprised of low density nano-porous silver catalyst.

5. The method of claim 1 wherein the catalyst is retained in the pressurized reaction vessel by a catalyst retention screen.

6. The method of claim 1 comprising the additional step of cooling the liquid water in a heat exchanger disposed downstream of the reaction vessel.

7. The method of claim 1 comprising the additional step of condensing a portion of the non-condensible moiety in a condenser disposed downstream of the reaction vessel, and returning the condensed portion of the non-condensible moiety to the reaction vessel.

8. The method of claim 1 comprising the additional step of controlling the pressure within the reaction vessel with a back pressure control valve in a gaseous discharge line.

9. The method of claim 1 wherein the oxygen concentration of the gaseous effluent is controlled by the removal of liquid water from the system.
